(19) United States
(12) Patent Application Publication
(10) Pub. No.: US 2010/0002700 A1
(43) Pub. Date: Jan. 7, 2010

(54) Methods and Systems for Network Packet Routing Using Embedded Geographic Routing Information

(75) Inventor: Charles Robert "Robby" Simpson, JR., Campobello, SC (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Cellnet Innovations, Inc., Alpharetta, GA (US)

(21) Appl. No.: 12/166,786

(22) Filed: Jul. 2, 2008

(51) Int. Cl. H04L 12/56

(52) U.S. Cl. 370/392

(57) ABSTRACT

Systems and methods for network packet routing using geographic information, for example, for routing packets in an IP communication network using geographic routing information embedded in a packet's IP address. One method comprises assigning a device's geographic location and including in its IP address a subnet prefix and a portion comprising an identifier indicative of the device' geographic location. One method facilitates routing of a packet by addressing the packet to a destination device with an IP address comprising a subnet prefix and a portion comprising an identifier indicative of the device's geographic location. The method may further comprise routing the packet from a source device to the destination device using the identifier. One embodiment is a system of a subnet of IP compatible nodes. One or more of these node devices are assigned an IP address comprising a subnet prefix identifying its respective subnet and a portion comprising an identifier indicative of its geographic location. One or more router nodes may be capable of using the geographic location of an IP address in a packet to route the packet, for example to select to which subsequent node to send the packet.

### TECHNICAL FIELD

Methods and systems of the present disclosure relate generally to geographic-based packet routing in an Internet Protocol (IP) network and other networks.

### BACKGROUND

Various routing methods are known for computer network packets. For example, U.S. Pat. No. 4,939,726 entitled “Method for routing packets in a packet communication network,” which is incorporated by this reference, describes forwarding packets from a source node to a target node via a series of intermediates using the target node's geographic coordinates, which are made part of or derived from the target node address that is included in the packet headers. Each intermediate node selects a successor node using, among other things, the maximum forward geographic progress attainable, which is determined by calculating a metric incorporating the geographical distance between the coordinates of the target node and the coordinates of each potential successor node. U.S. Pat. No. 5,636,216, entitled “Method for translating IP addresses to other distributed network addressing schemes,” which is incorporated by this reference, describes using a network specific local address of a target node that incorporates the target's geographic coordinates.

### SUMMARY OF THE INVENTION

Certain embodiments of the invention provide systems and methods for network packet routing using geographic routing information that is embedded in the address of a packet. For example, certain embodiments provide a method for assigning an IP address for routing packets in an IP communication network. One such method comprises assigning geographic location coordinates to a device of the IP communication network. The geographic location coordinates of the device identify the approximate geographic location of the device. This exemplary method also involves determining an IP address for the device, the IP address comprising (a) a subnet prefix and (b) a portion comprising an identifier indicative of the geographic location of the device. Such an IP address may also comprise additional information including, for example, information useful in distinguishing amongst devices located at the same location.

Certain embodiments of the present invention relate to systems and methods for routing packets of data. One method for facilitating the routing of a data packet comprises addressing a packet to a destination device of a plurality of devices by including an IP address of the destination device in the packet, the IP address of the destination device comprising (a) a subnet prefix and (b) a portion comprising an identifier indicative of the geographic location of the device. The geographic location of the destination device identifies the approximate geographic location of the destination device. The method may further comprise routing the packet from a source device to the destination device using the identifier indicative of the geographic location of the destination device.

Certain embodiments of the present invention provide interoperable networks that allow geographic based packet routing. One such system comprises a first subnet of IP compatible nodes and a second subnet of IP compatible nodes. One or more of these node devices are assigned an IP address comprising (a) a subnet prefix identifying its respective subnet and (b) a portion comprising an identifier indicative of its geographic location. One or more router nodes may be capable of using the geographic location of an IP address of a packet to route the packet, for example to select to which subsequent node to send the packet.

These embodiments are mentioned to provide examples and aid understanding. Additional embodiments and advantages are also discussed in the Detailed Description and will become readily apparent to those skilled in the art. As will be realized, the invention is capable of other and different embodiments, and its several details are not essential, but rather are capable of modifications in various obvious respects, all without departing from the invention. Accordingly, the drawings and description are to be regarded as illustrative in nature, and not as restrictive.

### BRIEF DESCRIPTION OF THE FIGURES

The above described and other features, aspects, and advantages of the present disclosure are better understood when the following Detailed Description is read with reference to the accompanying drawings, wherein:

FIG. 1 illustrates an exemplary network environment for certain embodiments of the invention;

FIG. 2 illustrates an exemplary node address for certain embodiments of the invention;

FIG. 3 illustrates an exemplary method for assigning an IP address for routing packets in an IP communication network according to certain embodiments of the invention; and

FIG. 4 illustrates an exemplary method for routing packets of data according to certain embodiments of the invention.

### DETAILED DESCRIPTION

An exemplary embodiment of the present disclosure extends existing geographic routing mechanisms into the standard, interoperable Internet Protocol (IP). IP is a data-oriented, network layer protocol generally used for communicating data across a packet-switched inter-network. IP version 4 (IPv4) addresses are usually represented in dotted-decimal notation (four numbers, each ranging from 0 to 255). IP version 6 (IPv6) addresses are 128 bits and consists of eight, 16-bit fields, with each field containing a hexadecimal number bounded by a colon. IPv6 addresses are well suited for use in certain embodiments of the present invention and thus used in the following exemplary embodiments.

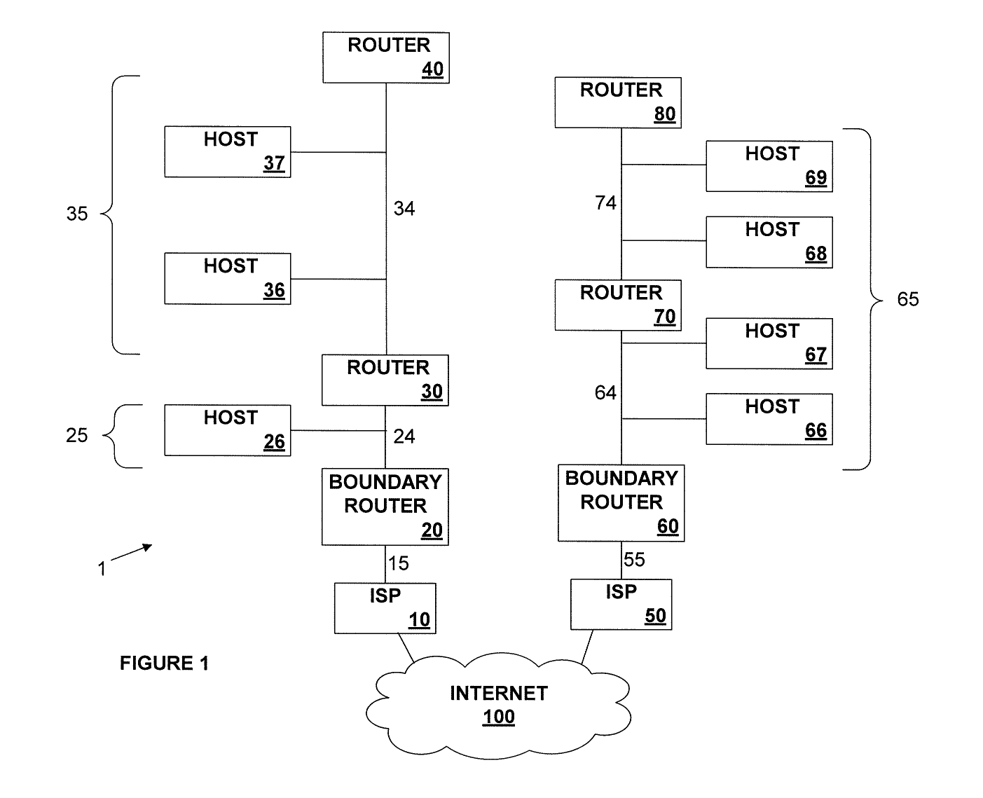

FIG. 1 illustrates an exemplary network environment for certain embodiments of the invention. Here a network 1 is comprising two internet service providers (ISPs) 10, 50 connected to the Internet 100. The internal networks shown are comprised of nodes. A node is any system or component with an IP address and interface configured to support IP, including hosts and routers. A router is a node that forwards packets with at least one interface configured to support IP. A router can generally advertise the registered IP side prefix for an enterprise over the internal network. A host is a node with an IP address that does not forward packets and can have more than one IP interface. A link is a single, continuous network medium from one router to another.

Specifically, the network 1 comprises a first internal network of routers 20, 30, and 40 connected by links 24, 34 and a second internal network of routers 60, 70, 80 connected by links 64, 74. Each link is populated by hosts and terminated by a router. Each boundary router 20, 60 runs a tunnel (providing a virtual path) 15, 55 to an ISP 10, 50, which provides Internet connectivity for the network 1.

A subnet is any administrative segment of an IP network. As examples, host node 26 is administered by subnet 25 and host nodes 36, 37 are administered by subnet 35. However, multilink subnets may be used, where nodes on more than one link can be components of a single subnet. For example host nodes 66, 67 on link 64 and host nodes 68, 69 on link 74 are administered as a single subnet 65. Nodes on a link can also be administered in separate subnets.

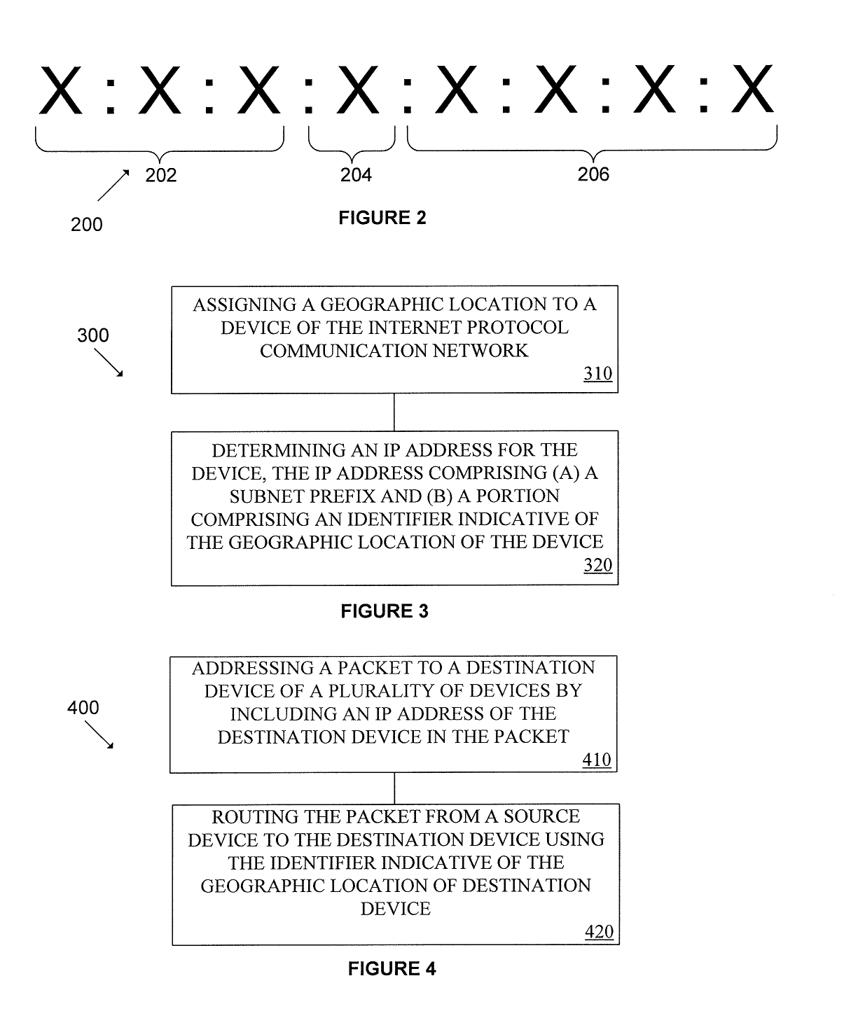

According to RFC 4291, “IP Version 6 Addressing Architecture,” some portion of an IPv6 address is reserved for “interface ID.” For example, FIG. 2 illustrates an exemplary node address 200 for certain embodiments of the invention. Here the first three segments of the address 200 represent a prefix 202, the next segment represents a subnet ID 204, and the final segments represent an Interface ID 206.

Certain embodiments of the present invention encode or otherwise embed geographic routing information into IP addresses, for example, by including such information in the interface ID portion 206 of an IP address 200. IPv6 nodes may have differing knowledge of the internal structure of the IP address, depending on the node's role, e.g., host versus router. As described in RFC 4291, a host may be aware of subnet prefix(es) for the link(s) it is attached to, where different addresses may have different values for n: subnet prefix (n bits); interface ID (128−n bits). Routers will generally have knowledge of one or more of the hierarchical boundaries for the operation of routing protocols. The known boundaries may differ from router to router depending on what position the router holds in a routing hierarchy. Also according to RFC 4291, except for knowledge about the subnet boundary, nodes will not make assumptions about the structure of an IPv6 address. According to RFC 4291, Interface IDs in IPv6 addresses are used to identify interfaces on a link. They are required to be unique within a subnet prefix and may be unique over a broader scope. In some cases, an Interface ID will be derived from that interface's link layer address. IPv6 interface ID field can include Ethernet layer address info, but under usual use of Ethernet layer that would not include geographic data.

Certain embodiments of the present invention utilize the capacity of the IPv6 addressing scheme (and perhaps other interoperable network addressing schemes) that provide sufficient address space and flexibility to include information about geographic routing and facilitate the routing of IP data with little or no routing overhead (i.e., one does not have to specify a complete path or involve the exchange of routing tables or routing packets) and thus little or no additional datagram bytes need be consumed.

For example, a geographic location may be entered or assigned at the time a node (or related) device is deployed, e.g., a handheld device or head end device could get the present street address and convert to latitude, longitude, altitude or any other useful geographic positioning information. This geographic information may then be associated with the node device and incorporated into the IPv6 interface ID created for that device. Obviously, various types of information can be used to assist with geographic routing, and thus such information is not limited to coordinate, direction, relative location, or any other specific type of such information, so long as such information can be used to route or assist with routing based on the node's geographic location. The geographic information may provide different levels of accuracy in differing dimensions and/or be used by routing algorithms that weight one geographic feature more than another in geographic-based routing decisions, e.g., by weighting latitude as more important than longitude. The geographic information may be encoded in one or more subsets of bits. A single subset of bits may represent a certain dimension, while another subset of bits represents another dimension. A single set of bits may encode multi-dimensional geographic information. Generally, the geographic information may be included, encoded, identified, referenced, or otherwise incorporated in an interface ID in a variety of alternative ways.

FIG. 3 illustrates an exemplary method 300 for assigning an IP address for routing packets in an IP communication network according to certain embodiments of the invention. The method comprises assigning a geographic location to a device of the IP communication network, as shown in block 310. The geographic location of the device identifies the approximate geographic location of the device and may be the coordinate location of the device, e.g., its latitude, longitude, and/or elevation, etc.

The method 300 also comprises determining an IP address for the device, as shown in block 320. The IP address comprising (a) a subnet prefix and (b) a portion comprising an identifier indicative of the geographic location of the device. It may comprise additional information as well. The subnet prefix may be used to allow routing to one or more subnets of the IP communication network.

FIG. 4 illustrates an exemplary method 400 for routing packets of data according to certain embodiments of the invention. The method comprises addressing a packet to a destination device of a plurality of devices by including an IP address of the destination device in the packet, as shown in block 410. The IP address of the destination device comprising (a) a subnet prefix and (b) a portion comprising an identifier indicative of the geographic location of the device. It may comprise additional information as well.

The method 400 may further comprise routing the packet from a source device to the destination device using the identifier indicative of the geographic location of destination device, as shown in block 420. As previously described, such routing may employ a variety of suitable techniques, including but limited to, routing the packet via a series of intermediates using the geographic coordinates of the destination, where each intermediate node selects a successor node by determining, among potentially other things, the maximum forward geographic progress attainable by candidate successor nodes.

In certain embodiments, methods and systems address the situation in which a packet comprising an IP address with a geographic location identifier is routed on a network that does not use geographic routing. In one exemplary method, a packet destined for a network that does use geographic routing traverses a network that does not. In this exemplary method, the geographic information in the IP address need not affect the normal behavior of the network being traversed.

### General

The foregoing description of the embodiments of the invention has been presented only for the purpose of illustration and description and is not intended to be exhaustive or to limit the invention to the precise forms disclosed. The techniques of the invention are not limited to particular systems, networks, or any other particular network configuration or protocol. Thus, in general, numerous modifications and adaptations are apparent to those skilled in the art without departing from the spirit and scope of the invention. For example, while FIG. 1 provides an exemplary network environment for certain embodiments of the invention, other embodiments will involve different network configurations, such as network configurations that do not utilize ISPs.

That which is claimed:

1. A method for assigning an IP address for routing packets in an IP communication network, the method comprising:
assigning a geographic location to a device of the IP communication network, the geographic location of the device identifying the approximate geographic location of the device; and
determining an IP address for the device, the IP address comprising (a) a subnet prefix and (b) a portion comprising an identifier indicative of the geographic location of the device.

2. The method of claim 1, wherein the subnet prefix allows routing to one or more subnets of the IP communication network.

3. The method of claim 1, wherein the geographic location of the device is the coordinate location of the device.

4. The method of claim 3, wherein the coordinate location of the device comprises the device's latitude and longitude

5. The method of claim 4, wherein the coordinate location of the device further comprises the device's altitude.

6. A method for facilitating the routing of a data packet, the method comprising addressing a packet to a destination device of a plurality of devices by including an IP address of the destination device in the packet, the IP address of the destination device comprising (a) a subnet prefix and (b) a portion comprising an identifier indicative of the geographic location of the device, the geographic location of the destination device identifying the approximate geographic location of the destination device.

7. The method of claim 6 further comprising routing the packet from a source device to the destination device using the identifier indicative of the geographic location of destination device.

8. The method of claim 7, wherein routing the packet further comprises using the subnet prefix.

9. The method of claim 6, wherein the subnet prefix allows routing to one or more subnets of the IP communication network.

10. The method of claim 6, wherein the geographic location of the destination device is the coordinate location of the device.

11. The method of claim 6, wherein the coordinate location of the destination device comprises the device's latitude and longitude.

12. The method of claim 11, wherein the coordinate location of the destination device further comprises the device's altitude.

13. A system comprising:
a first subnet comprising a network of IP compatible nodes; and
a second subnet comprising a network of IP compatible nodes;
wherein a node device of the first subnet is assigned an IP address comprising (a) a subnet prefix identifying the first subnet and (b) a portion comprising an identifier indicative of the geographic location of the node device.

14. The system of claim 13, wherein a node of the second subnet is assigned an IP address comprising (a) a subnet prefix identifying the second subnet and (b) a portion comprising an identifier indicative of the geographic location of the node device.

15. The system of claim 14, wherein a router node of the first subnet is capable of using the geographic location of an IP address of a packet to route the packet.

16. The system of claim 15, wherein the router node uses the geographic location of the node to select to which subsequent node to send the packet.
